(19) United States
(12) Patent Application Publication
(10) Pub. No.: US 2010/0260569 A1
(43) Pub. Date: Oct. 14, 2010

(54) Mill bed

(76) Inventors: Marnie Elizabeth Jean Ham, Port Hope (CA); Matthew Christopher Heilandt, Sarasota, FL (US)

Correspondence Address: DOWELL & DOWELL P.C., 103 Oronoco St., Suite 220, Alexandria, VA, 22314, US

(21) Appl. No.: 12/385,515

(22) Filed: Apr. 9, 2009

(51) Int. Cl. B23Q 1/01; B23C 9/00; G06F 19/00

(52) U.S. Cl. 409/80; 409/235; 700/159

(57) ABSTRACT

A mill bed for use in association with a mill includes a base frame, an outer frame and an inner frame. The outer frame is moveably attached to the base frame whereby it is at least partially rotatable around an outer axis. The inner frame is rotatably attached to the outer frame and at least partially rotatable around an inner axis. A control system is operably attached to the outer frame and the inner frame to control movement of the outer and inner frames.

### FIELD OF THE INVENTION

This invention relates to mill beds and in particular auxiliary mill beds with two axis whereby a three axis machine may be converted into a five axis machine.

### BACKGROUND OF THE INVENTION

With a high emphasise on lessoning manufacturing lead times new technologies have been developed to aid in the reduction of these periods, and the decrease of material loss. Single Point Incremental Forming (SPIF) has been developed to produce products normally formed on expensive and time consuming dies. Hence the term ‘dieless forming’ has been adopted by this new process. The process is simple; it requires no cutters or bulky material. The necessary components to perform the operation would be a riser to clamp the sheet metal to and a tool. The tool itself is a rotating shaft with no sharp edges making it safer to handle and use compared to conventional machine tools. When the tool comes into contact with the sheet metal it begins to press down upon it, allowing for the metal to be depressed. It continues this process until one full toolpath is completed, then, stepping down every cycle until the desired shape is achieved.

More specifically, the SPIF process starts by placing a blank (a dimensionally cut piece of sheet metal) in a blankholder or clamps which is elevated off of the mill bed. The reason for this is to allow for the depressing of the sheet metal. With the use of CNC technology a toolpath can be programmed to allow the tool to run on its own.

The tool begins by spinning up to the desired speed. It then begins to touch the surface of the part and follow the toolpath. In this process the X-Y plane is defined by the mill bed and the Z-axis is defined as the vertical movement perpendicular to the X-Y plane. After the initial path, lubrication is added by the operator to ensure no overheating will occur. The tool then moves in the -Z direction. An example of an SPIF run would be 0.002″ (0.05 mm), and proceeds around the toolpath; the depth is determined by the thickness of the sheet metal. It will continue to do so until it has completed its cycle, similar to a CNC operation with a conventional cutting tool.

Gyroscopes have been commonly used in the aerospace industry but very little in the manufacturing sector. A gyroscope provides a stable platform to maintain orientation, hence its use in the aerospace industry. The principles of a gyroscope are based on the conservation of angular momentum, meaning that the inner point will maintain its direction in space if the outer frame work changes.

This new process has gained much attention in the manufacturing sector for its ability to be proficient on a three-axis CNC milling machine. However, with more and more complex shapes being developed and tested, there is a need for a five-axis milling machine. In addition there is a need to be able to convert three-axis milling machines into five-axis milling machines. Some improvements have been suggested, however, they do not convert a three-axis milling machine into a five-axis milling machine.

For example, Washburn developed a work piece holder with the ability to tilt in one direction as shown in U.S. Pat. No. 4,397,245 issued Aug. 9, 1983. His design is capable of withstanding large loads and easy to control. However, its overall weight is a concern when it is to be lifted manually. Its ability to only tilt in one direction is one of its limitations, the cost of the unit is another concern and the calibration of the device can be difficult due to its pneumatic actuators.

Another example is shown in Matsubara who developed a dieless forming device which is able to clamp and press the sheet against a mandrel as shown in U.S. Pat. No. 6,216,508 issued Apr. 17, 2001. It is similar to the box frame idea but this device itself presses the sheet metal. This is a very effective design, however, it is limited to the complexity of the parts being produced.

Accordingly it would be advantageous to provide a device that can turn a three-axis milling machine into a five-axis milling machine. Further it would be advantageous to provide a milling bed that includes some of the capabilities of a gyroscope.

### SUMMARY OF THE INVENTION

The present invention relates to a mill bed for use in association with a mill. The mill bed includes a base frame, an outer frame and an inner frame. The outer frame is moveably attached to the base frame whereby it is at least partially rotatable around an outer axis. The inner frame is rotatably attached to the outer frame and at least partially rotatable around an inner axis. A control system is operably attached to the outer frame and the inner frame to control movement of the outer and inner frames.

The mill bed may be clamped to or otherwise attached to a three axis mill bed thereby converting it into a five axis mill bed. In another embodiment the mill bed may further include translational movement and form part of a five axis mill bed.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of a mill with one embodiment of the auxiliary mill bed of the present invention attached to the three axis mill bed of the mill;

FIG. 2 is an enlarged perspective view of the auxiliary mill bed of the present invention;

FIG. 3 is an enlarged perspective view of an alternate auxiliary mill bed of the present invention showing a backing plate;

FIG. 4 is an enlarged perspective view of an alternate auxiliary mill bed of the present invention showing an alternate inner frame;

FIG. 5 is an enlarged perspective view of an alternate auxiliary mill bed of the present invention showing a solid backing plate;

FIG. 6 is an enlarged perspective view of an alternate auxiliary mill bed of the present invention showing an alternate base frame;

FIG. 7 is a perspective view of one embodiment of the auxiliary mill bed of the present invention used in association with a drill press;

FIG. 8 is a perspective view of one embodiment of the auxiliary mill bed of the present invention used in association with a lathe; and

FIG. 9 is a perspective view of a mill with an improved mill bed of the present invention.

### DETAILED DESCRIPTION OF THE INVENTION

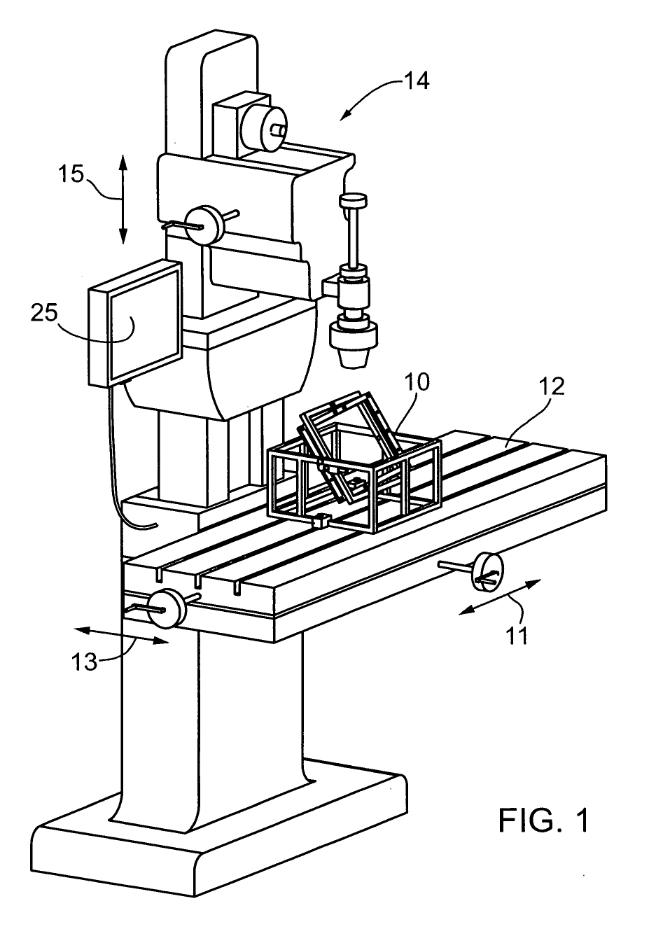

Referring to FIG. 1 the auxiliary mill bed of the present invention is shown at 10. Auxiliary mill bed 10 is for use in conjunction with among other devices a two axis mill bed 12 and a milling machine 14. The auxiliary mill bed 10 converts a three-axis milling machine into a milling machine with five-axis capabilities. Mill bed 12 is movable in the x direction 11 or longitudinally in a plane orthogonal to the movement of the tool and the y direction 13 or laterally as shown by the arrows. Mill 14 is movable in the z direction 15 and defines an upwardly and downwardly path for the tool. Auxiliary mill bed 10 may be clamped or bolted to mill bed 12.

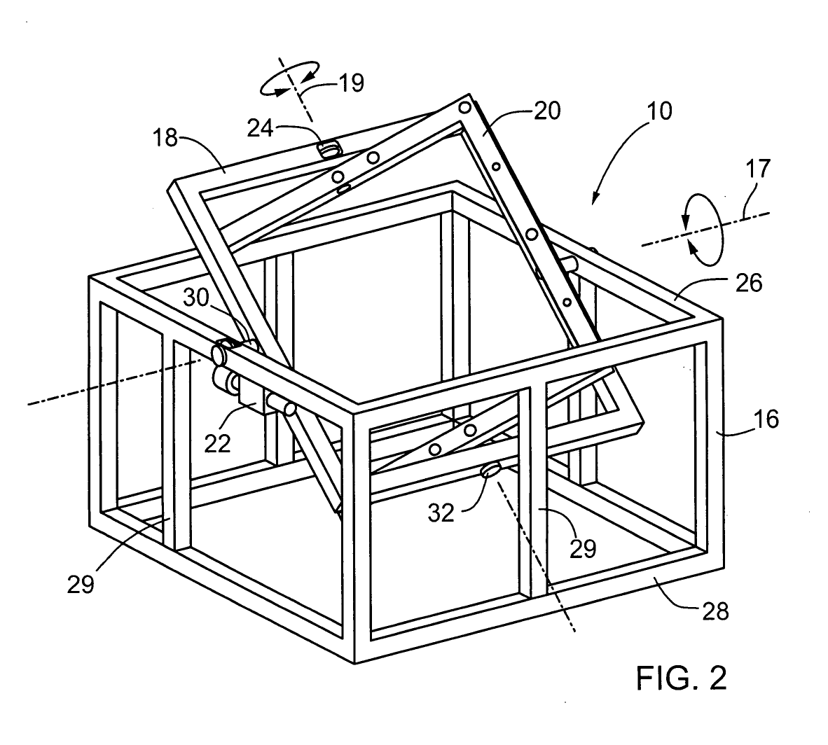

Referring to FIG. 2, the auxiliary mill bed 10 includes a base frame 16 which is used to elevate the rotating parts of the device. An outer frame 18 is rotatably attached to the base frame 16. An inner frame 20 is rotatably attached to the outer frame 18. The outer frame 18 has an axis of rotation 17 and the inner frame 20 has an axis of rotation 19. A control system is operably attached to the outer frame 18 and the inner frame 20 to control movement of the outer and inner frames. More specifically, the outer frame 18 is rotated by use of an outer drive train system 22 hanging from the base frame 16. The inner frame 20 similarly has an inner drive train system 24 attached to the outer frame 18.

The base frame 16 is preferably welded as one solid frame. Alternatively the vertical supports 24 may be bolted to the upper 26 and lower 28 frames of the base frame 16. This does have an advantage because it makes the device modular. It can be assembled on the milling bed to reduce the lifting weight or the device may be assembled on a bench and then lifted into place. Preferably base frame 16 includes side supporting legs 29. Preferably side supporting legs 29 on the side with the outer drive train system 22 is offset.

FIG. 2 illustrates how the inner 20 and outer 18 frames rotate within the base frame 16. The outer frame 18 is rotated around outer pins 30 placed on each side of the base frame 16. Outer pins 30 form part of the outer drive train system 22. Similarly, the inner frame 20 is rotated around inner pins 32 which attached between the inner frame 20 and the outer frame 18. The inner pins 32 form part of the inner drive train system 24.

It will be appreciated by those skilled in the art that a variety of different drive train systems may be used for the outer drive train 22 and the inner drive train 24. One alternative is to use a worm gear system which is a self locking device in which the worm drives the wheel. Worm gear systems are typically found in metal lathes where the worm drives the shaft to which the tool post is attached. This provides the forces needed to counter the reaction forces exerted by the work piece. Alternatively step motors may be used in the inner and outer drive trains. This allows for easier use when tilting and also it removes human involvement. Preferably the step motors are programmable and integrated into the CNC program such that the program can rotate the frames without any human involvement and allow for complex parts to be produced in less time. Preferably the control system operably attached to a display screen 25.

It will be appreciated by those skilled in the art that inner 20 and outer 18 frames are able to rotate 360 degrees. However, depending on the tool being used, the maximum working angle changes significantly. The angles available also change on the device depending on the opening of the backing plate.

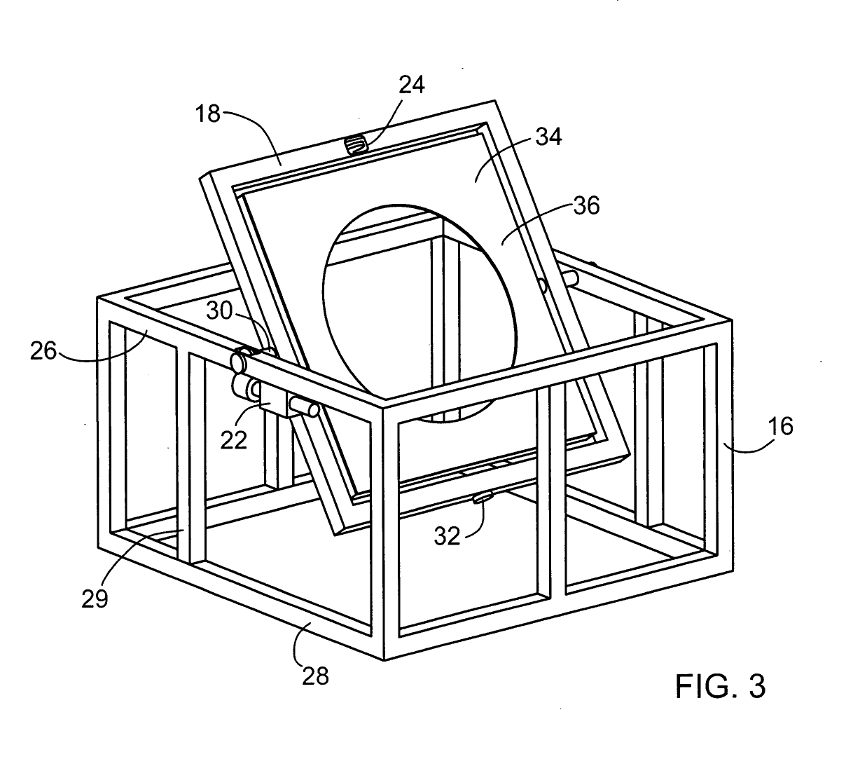

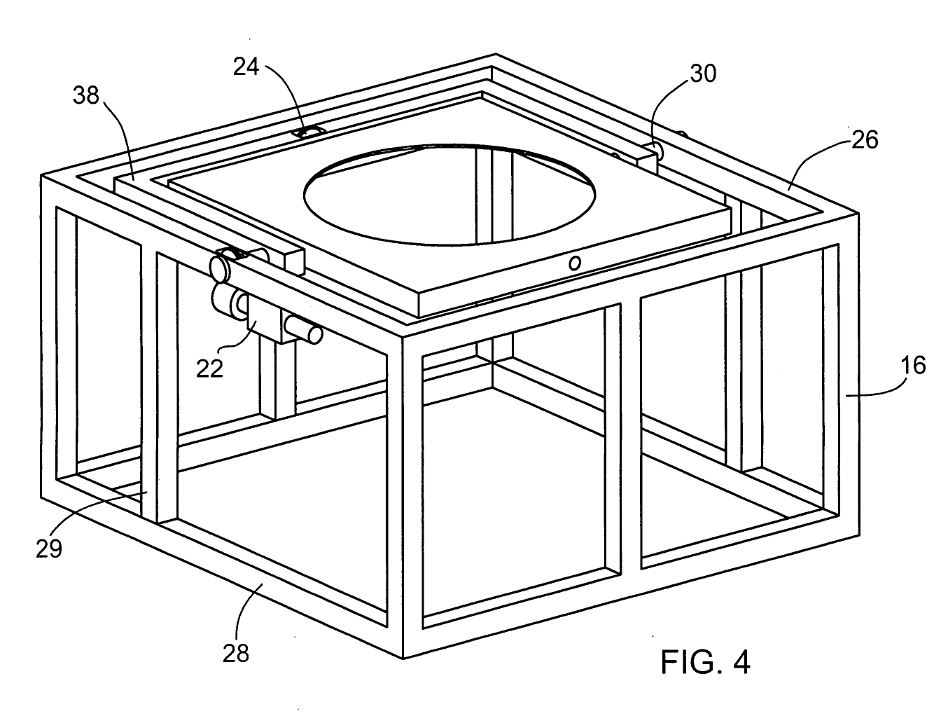

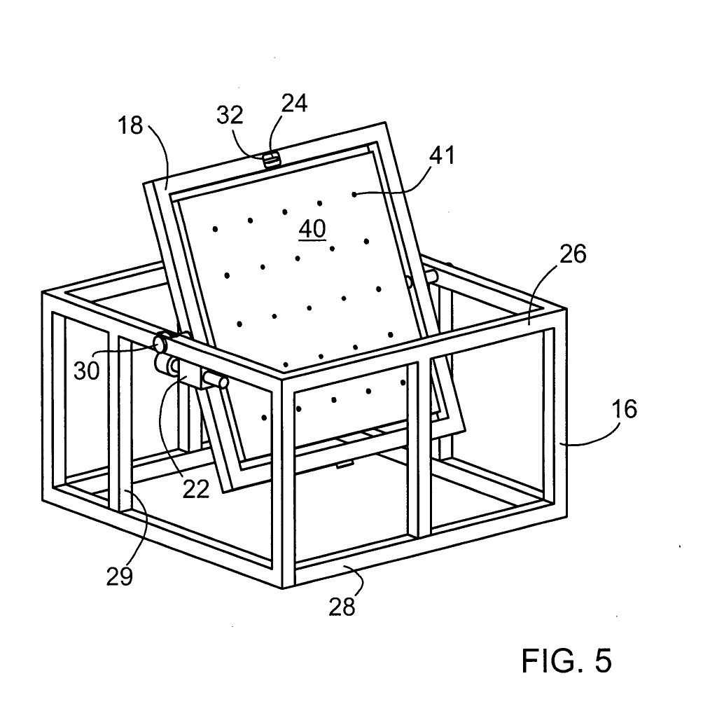

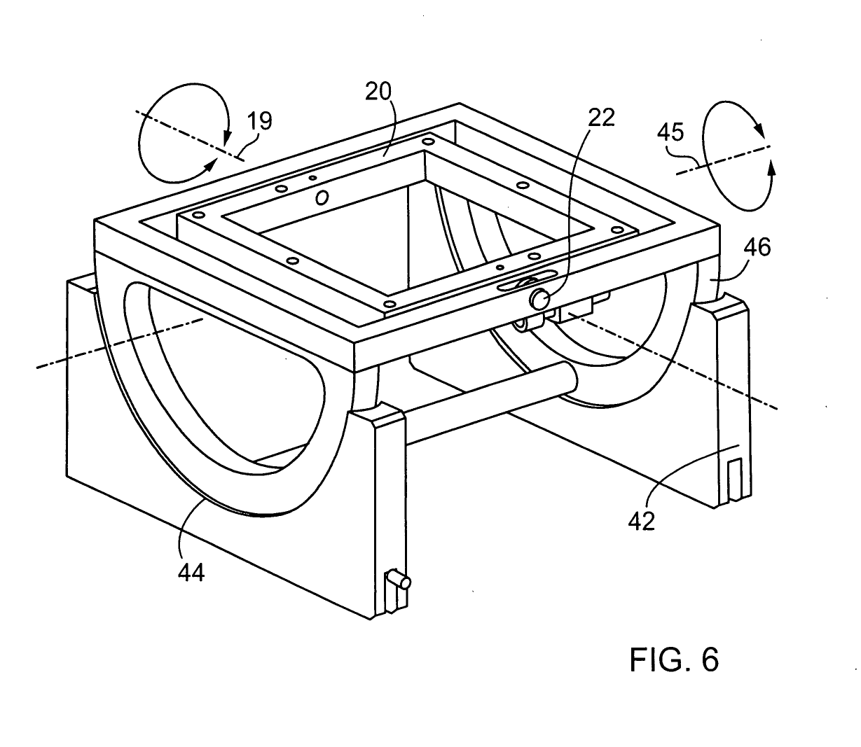

It will be appreciated by those skilled in the art that there are a number of modifications that may be made to the design while remaining within the general concept of the present invention. For example the inner frame may be replaced with an inner backing plate 34 having a hole 36 formed therein as shown in FIG. 3. Alternatively outer frame 38 may be modified such that it frames half of the inner frame as shown in FIG. 4. The modified outer frame 38 allows the frames to rotate without the tool coming into contact with the outer frame. It will be appreciated by those skilled in the art that the stresses on the inner and outer pins will be increased with this design modification. Another embodiment is shown wherein the inner frame is replaced with a solid backing plate 40 with a plurality of threaded holes 41 formed therein as shown in FIG. 5. FIG. 6 shows an alternate base 42 with an arcuate seat 44 for the outer frame 46. The arcuate seat 44 defines an axis of rotation 45. The inner frame 20 is similar to that described above.

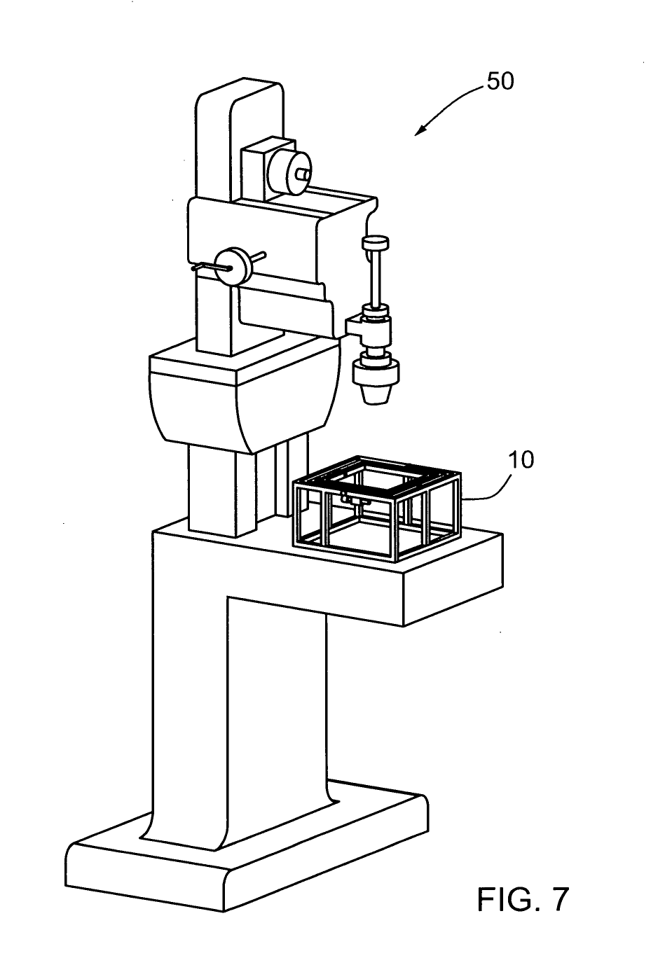

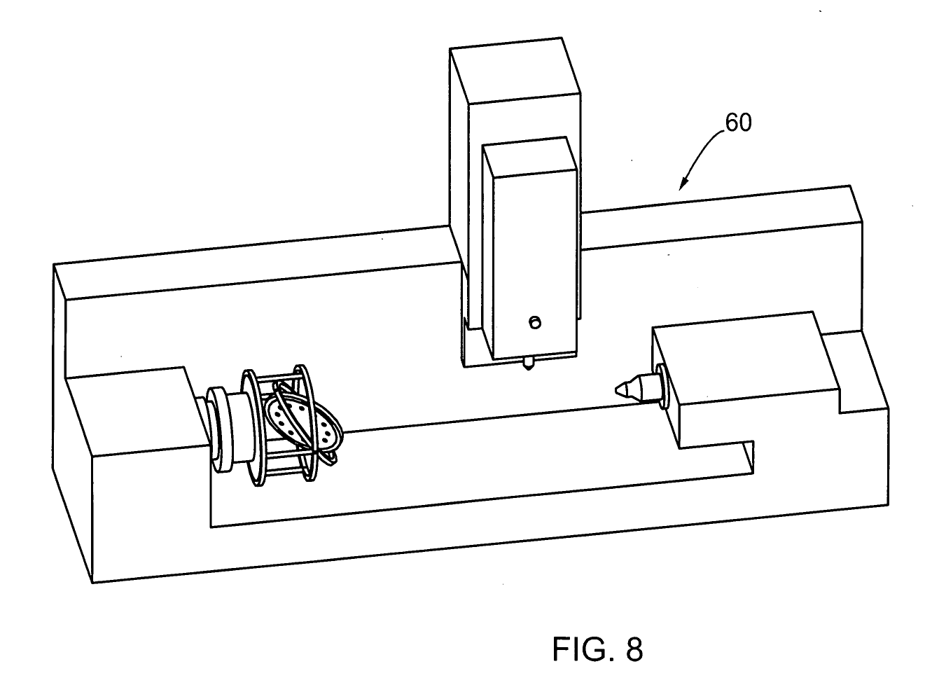

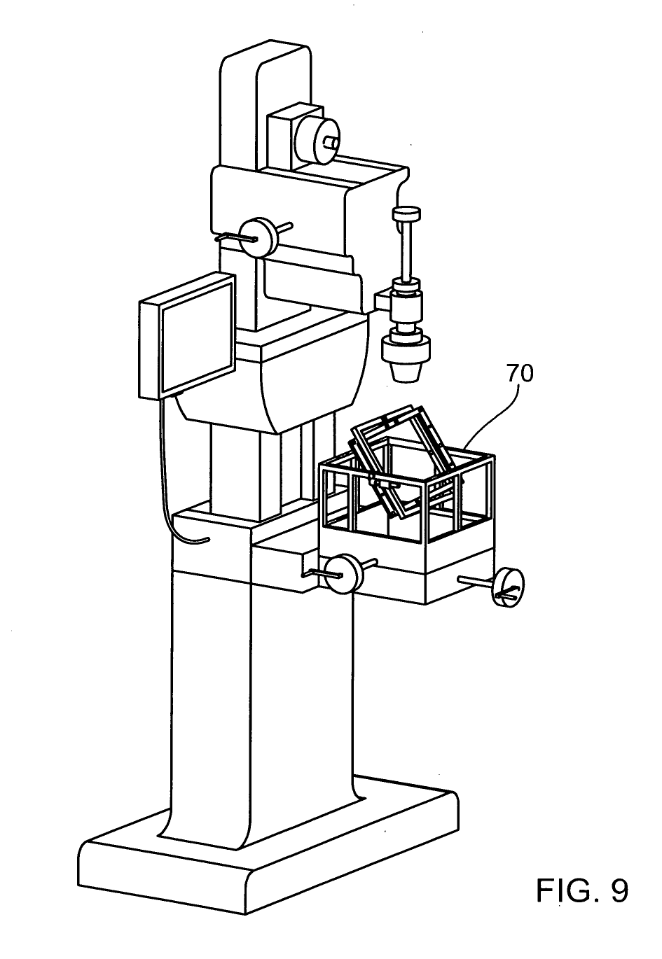

It will be appreciated by those skilled in the art that the different embodiments of auxiliary mill bed may be used in association with a number of devices. Particularly as shown in FIG. 1 it may be used in association with a three degree of freedom mill 14. Alternatively it may be used with association with a drill 50 press as shown in FIG. 7 or a lathe 60 as shown in FIG. 8. Alternatively the gyroscopic design of the auxiliary mill bed may be used to modify a mill bed 70 for any of these devices and an example of this is shown in FIG. 9.

Generally speaking, the systems described herein are directed to mill beds. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to mill beds.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed as the invention is:

1. A mill bed for use in association with a mill comprising:
a base frame;
an outer frame moveably attached to the base frame whereby it is at least partially rotatable around an outer axis;
an inner frame rotatably attached to the outer frame and at least partially rotatable around an inner axis; and
a control system operably attached to the outer frame and the inner frame to control movement of the outer and inner frames.

2. The mill bed as claimed in claim 1 wherein the outer axis and the inner axis intersect.

3. The mill bed as claimed in claim 2 wherein the outer frame is rotatably attached to the base frame.

4. The mill bed as claimed in claim 3 wherein the control system includes an outer drive train system operably connected between the base frame and the outer frame and an inner drive train system operably connected between the outer frame and the inner frame.

5. The mill bed as claimed in claim 4 wherein the outer drive train system and the inner drive train system each include one of a worm gear and a stepping motor.

6. The mill bed as claimed in claim 4 wherein the control system is operably connected to a computer such that movement of the outer frame and the inner frame are controlled automatically.

7. The mill bed as claimed in claim 3 wherein the inner frame is an inner backing plate with a hole formed therein.

8. The mill bed as claimed in claim 3 wherein the inner frame is a backing plate with a plurality of threaded holes formed therein.

9. The mill bed as claimed in claim 2 wherein the mill bed is attached to a mill having a tool that moves in a direction upwardly and downwardly.

10. The mill bed as claimed in claim 9 wherein the mill bed is moveable longitudinally in a plane generally orthogonal to the direction of the tool.

11. The mill bed as claimed in claim 10 wherein the mill bed is further moveable laterally in the plane.

12. The mill bed as claimed in claim 11 wherein the control system includes an outer drive train system operably connected between the base frame and the outer frame and an inner drive train system operably connected between the outer frame and the inner frame.

13. The mill bed as claimed in claim 12 wherein the control system is operably connected to a computer such that movement of the outer frame and the inner frame are controlled automatically.

14. The mill bed as claimed in claim 11 wherein the mill is one of a CNC machine and a drill press.

15. The mill bed as claimed in claim 2 wherein the mill is a lathe.

16. The mill bed as claimed in claim 2 wherein the base frame has an arcuate seat and the outer frame is moveably attached to the seat.

17. The mill bed as claimed in claim 16 wherein the control system includes an outer drive train system operably connected between the base frame and the outer frame and an inner drive train system operably connected between the outer frame and the inner frame.

18. The mill bed as claimed in claim 17 wherein the control system is operably connected to a computer such that movement of the outer frame and the inner frame are controlled automatically.
